(19) United States
(12) Patent Application Publication
(10) Pub. No.: US 2024/0009598 A1
(43) Pub. Date: Jan. 11, 2024

(54) FILTER APPARATUS

(71) Applicant: Fidica GmbH & Co. KG, Hosbach (DE)

(72) Inventors: Manfred Volker, Blankenbach (DE); Andre Schuhmacher, Alzenau (DE); Thomas Reinhart, Niedernberg am Main (DE)

(21) Appl. No.: 18/178,461

(22) Filed: Mar. 3, 2023

(30) Foreign Application Priority Data
Jul. 6, 2022 (DE) 20 2022 103 779.5

(51) Int. Cl. B01D 27/08; B01D 27/02; B01D 27/14; B01D 27/04; C02F 1/00

(52) U.S. Cl. CPC B01D 27/08; B01D 27/02; B01D 27/146; B01D 27/04; C02F 1/001; B01D 2201/34; B01D 2201/291; B01D 2201/06; B01D 2201/16; B01D 2201/4092; C02F 2103/04

(57) ABSTRACT

A filter apparatus connected a container, where the container includes a container neck and is filled with a filling material. The filter apparatus includes a filtrate riser tube in the container, which extends from the base region of the container to the container neck, a container connector head, which is fastened to the container neck and defines passages connected to a liquid inlet line and an inlet filter, and a connector unit with a sealing piston in the connector unit, which is arranged so as to be lowerable to connect the liquid inlet line to the filter material in the container and the filtrate riser tube to the filtrate outlet line.

### Priority Claim

The subject application claims convention priority to German patent application No. DE 20 2022 103 779.5, filed Jul. 6, 2022.

### BACKGROUND

It is the object of the development to utilise a large volume disposable filter in an economical manner for different filtering purposes, with which ready to use ultrapure water or drinking water can be prepared from raw water, for instance for laboratory, pharmaceutical and medicinal applications.

The filter is to be connected with minimal handling effort, have good hygienic properties and be codable for different filter media.

Exchanger resins, such as mixed bed resins, and also filter charcoal or special filter media for arsenic and nitrate and also their combination can be used as filter materials.

Ready to use ultrapure water for laboratory applications was previously mostly produced by a multistage pressure-filtration process, wherein as a rule few consumable materials are required. The technology is, however, high maintenance and results in high costs in the event of a fault-based malfunction. The known chemical exchange filtration with mixed bed resins and subsequent polishing resins is technically problem free but results in higher usage costs.

The removal previously encountered of filter media from the filter container can result in contamination of the clean regions of the filter apparatus, whereby appropriate auxiliary materials are required for emptying and refilling a filter apparatus.

There is a need for a filter apparatus which is simple to handle and meets the highest requirements as regards storage, hygiene and quality. Furthermore, such a filter apparatus is to result in low purchase costs and operating costs.

### SUMMARY

The invention provides that the filter apparatus includes a container, which is provided with a container neck and which is preferably manufactured in a plastic blow moulding process and is filled with a filter material. The container manufactured from PET or HDPE conveniently has a spherical or bottle-shaped shape and a preferred capacity of 5-50 I. The wall thickness should be less than 1 mm. A container connector head is fastened to the container neck, which affords beads or screwthreads, by surrounding locking or screwthread fastenings.

The transparent, or optionally coloured, PET or HDPE container advantageously has a perforated base of a hydrophilic material, grit or rigid structural elements, on which the filter medium is disposed. Different filter media can be arranged in layers separated e.g. by hydrophilic separation layers.

The filtrate riser tube is passed through the filter medium in a positive locking manner from the perforated base into the container connector head. The filtrate riser tube is preferably held at the upper end region in the container connector head. The upper fastening of the filtrate riser tube is effected in a groove, into which a surrounding snap lock on the container connector head engages.

Situated in the container connector head there is a foamed material or filter fleece, through which the crude water flowing in from above can flow downwardly in a distributed manner. Escape of the filter material is also prevented.

The filtrate riser tube can be inserted into a layer, arranged on the base of the container, of a hydrophilic foam material or filter fleece and have holes for the entry of filtered filtrate in the inserted end section. The lower openings in the filtrate tube can be covered by an additional screen to prevent the entry of filter medium.

A connector unit, which has a horseshoe-shaped receiving groove on its underside, is pushed with great advantage onto the annular mounting collar on the container connector head.

In order to fix and seal the connector unit onto the container or the container connector head, after fully pushing on the connector unit, a handle, which is constructed as an eccentric lever, is completely pivoted through 180° and thus connects the connector unit to the container. A connector collar on the sealing piston thus presses onto a bottle lip seal on the connector unit and thus produces a positive, sealing connection of the connector unit and the filter bottle.

A lower, stepped bore in the sealing piston advantageously surrounds the upper end of the filtrate riser tube and seals it by means of an 0-ring. Different filter media or containers may be codably connected in a manner which prevents confusion by matched dimensions of this stepped bore in the sealing piston with the filtrate tube.

In the filter apparatus in accordance with the invention, the filtering process is initiated by the sealing piston in the connector unit by it being lowered by the eccentric lever, whereby the raw water can flow out of the raw water supply line into the filter material in the container and filtered ultrapure water or filtrate flows out of the filter apparatus through the filtrate riser tube and the filtrate discharge line.

The raw water flows into the container, either as a result of the water pressure in the supply line or due to the pressure produced by a pump and it runs out of the container in the form of filtrate due to this water pressure. Only a low water pressure of less than 2 bar is necessary for this filtering process so that the container need have only a small wall thickness of ca. 0.5 mm in order to withstand the operating pressure.

In accordance with a further proposal, an elongate blind hole is formed in the sealing piston, which extends in the axial direction of the sealing piston and starts from the lower end of the sealing piston. The blind bore extends approximately over half the length of the sealing piston and is connected at the upper, closed end region with a transverse bore extending in the transverse direction through the sealing piston. Extending through the connector unit spaced above one another there are two passages passing transversely through the connector unit to the sealing piston, whereby the passages are provided externally on the connector unit with hose connectors, to which the raw water supply line and the filtrate discharge line may be connected.

In the lowered position of the sealing piston, the upper of these two passages is connected to the transverse bore in the sealing piston so that filtrate can flow out of the filter apparatus.

In the lowered position of the sealing piston, the supplied liquid flows via an annular gap, which extends around the sealing piston, via its liquid passages and inlet kidneys in the sealing piston through the upper filter screen and further via the lower perforated openings in the container connector head into the filter medium in well distributed form.

The liquid flows back uniformly distributed as filtrate via the perforated base into the filtrate riser tube via the central bore in the sealing piston.

The liquid supply or the filtrate discharge can optionally be reversed with respect to the described form.

It can furthermore be provided that a venting passage with a venting valve extends from the exterior through the connector unit to the annular gap or cavity around the sealing piston and that the venting valve includes an actuating element, which opens the venting valve in response to pressure. Air or an air/water mixture can flow out from the interior of the container, conveniently via the annular gap and a special air outlet opening through a small hose so that practically the entire interior of the container can be filled with liquid passing through.

If the performance capability of the filter material is depleted, the container is discarded together with the filter material and the filtrate riser tube and replaced by a new structure, whereby merely the connector unit, which can be permanently connected to the raw water supply line and the filtrate discharge line, is retained for the next usage.

For the purpose of decoupling the bottle from the connector unit, the eccentric lever is fully pivoted, the sealing piston pulled upwardly and the pressed lip seal is released, and the connector unit can thereby be separated or laterally withdrawn from the container connector head. An outflow of liquid from the connector unit is prevented by the peripheral sealing rings so positioning the sealing piston that the inlet and filtrate openings are closed and the connector thus does not drip.

The filter apparatus is associated with low manufacturing costs due to its simple construction. Handling is extremely simple and the operating costs are minimal. The container material is easily recyclable.

### BRIEF DESCRIPTION OF THE DRAWINGS

Further details of the invention will be apparent from the following description of one preferred embodiment and with reference to the drawings, in which:

FIG. 1 shows an embodiment of the filter apparatus in accordance with the invention and

FIG. 2 shows an enlarged view of the filter apparatus of FIG. 1.

FIG. 3 shows a fragmentary view of the filter apparatus of FIG. 2.

FIG. 4 shows an enlarged view of the filter apparatus of FIG. 1.

FIG. 5 shows an enlarged view of the sealing piston of the filter apparatus of FIG. 1.

FIG. 6 shows an enlarged view of the filter riser tube of the filter apparatus of FIG. 1.

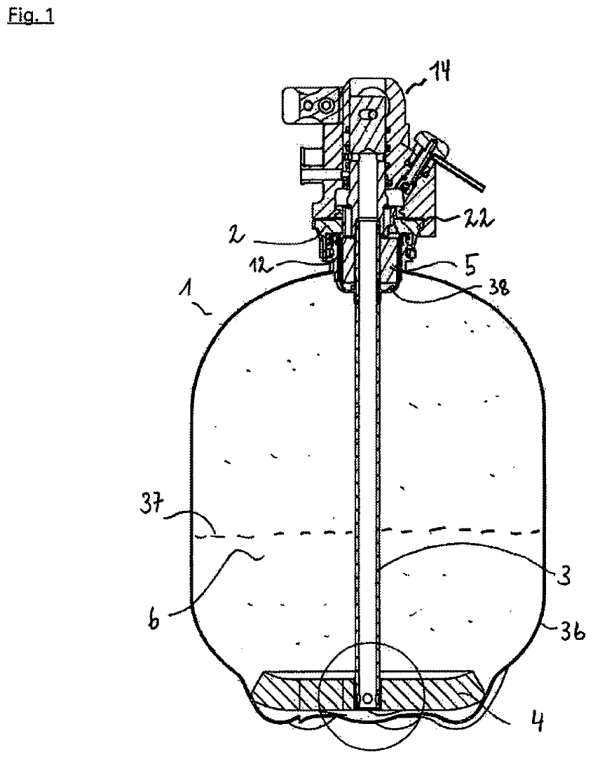

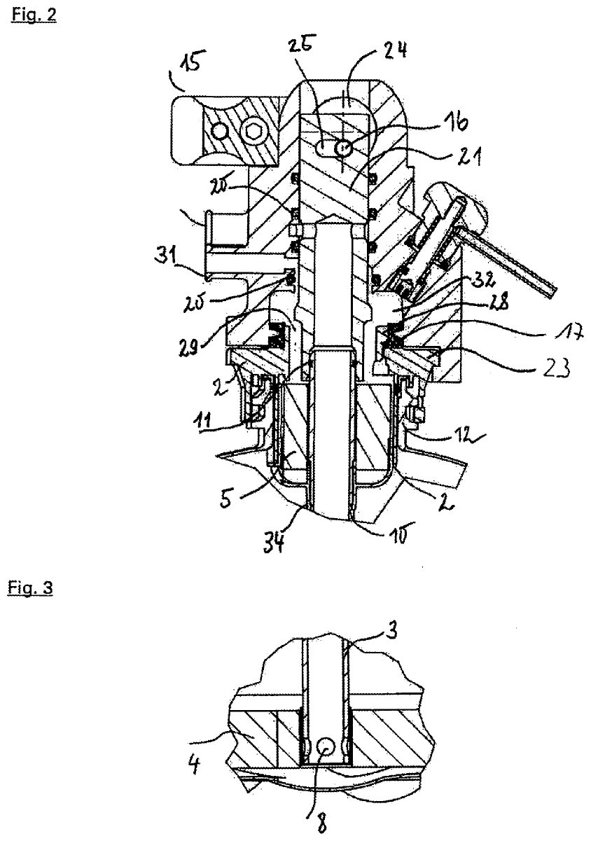

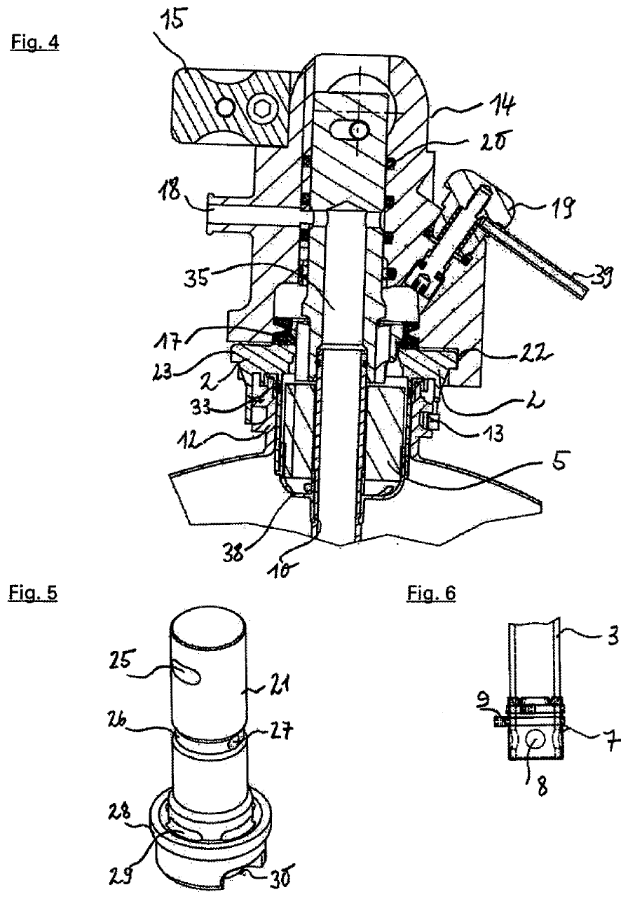

### DETAILED DESCRIPTION

The container/filter bottle (1) with the transparent bottle (36), the container neck (12) with its beads or screwthreads (33) and the container connector head (2) secured to it.

The lower end of the filtrate riser tube (3) is positively connected to the perforated base (4) and its upper end is firmly connected in a locking manner (34) in the container connector head (2) and to a groove (10).

A separate, external connector unit (14) is pushed with a receiving groove (22) into the receiving collar (23) on the container connector head (2) and can be sealingly secured by means of an eccentric lever (15).

The filter bottle (1) is filled with filter medium (6). When using different filter media, these can be separated by separation layers (37).

For the purpose of connecting the connector unit (14), the eccentric lever (15) is pivoted to the right through 180° from the illustrated position and the eccentric pressure pin (16), which is secured in the eccentric (24), thereby pulls a sealing piston (21) upwardly and releases the squeezed container lip seal (17). The connector unit (14) with the horseshoe-shaped groove (22) can thus be released from the receiving collar (23) on the container connector head or pushed onto it.

The filtration process is initiated with the container connector head (2) with the connector unit (14) connected. The container lip seal (17) produces a sealing, positive connection. The liquid flows via the liquid inlet connector (31), which can also be constructed in the form of a coupling, externally of the sealing piston (21) via annular gap (32) and kidneys (29) through an upper filter screen (5) and perforated openings in the container connector head into the filter medium downwardly towards the perforated base (4).

The liquid flows through the perforated base to the openings (8) in the filtrate riser tube (3). These openings can also have other geometries. The liquid is conducted through the filtrate riser tube (3) upwardly to a bore in the sealing piston (35) and is there conducted further to the connector unit via a filtrate bore (27) and filtrate groove (26) via the connector (18).

The lower end of the sealing piston (21) engages, sealed by an 0-ring, in the filtrate riser tube (3). The stepped construction of the bore (35) can be constructed to geometrically match the filtrate riser tube (3) to form connections free of the risk of confusion.

Sealing with respect to the surroundings is prevented by the four sealing rings (20). Air situated in the container (1) can be guided via a positioned air outlet opening (30), inlet kidneys (29) and annular gap (32) to the venting valve (19). Air or air-water mixture can be conducted via a line (39) to the exterior by pressing the venting valve.

Used or depleted filter medium (6) can be detected by means of conductivity, volumetric or other measuring techniques. For the purpose of disconnection of the filter bottle (1), the eccentric lever (15) is fully pivoted, as described above, and the pressure collar (28) on the sealing piston (21) thus releases the container lip seal (17).

The filter container (1) with the container connector head (2) can be separated from the connector unit (14). As a result of the sealing piston (21) being pulled upwardly, the four O-rings (20) seal the filtrate outlet (18) and also the liquid inlet (31). Discharge of liquid in the disconnected state is thus prevented.

1. A filter apparatus apparatus a container including a container neck where the container is filled with a filter material, the filter apparatus comprising;
a filtrate riser tube in the container, which extends from the base region of the container to the container neck;
a container connector head, which is fastened to the container neck and affords passages, which are connected to a liquid inlet line and an inlet filter and a connector unit with a sealing piston in the connector unit, which is arranged to be lowerable in order to connect the liquid inlet line to the filter material in the container and the filtrate riser tube to the filtrate discharge line.

2. The filter apparatus as claimed in claim 1, wherein the container is produced in a blow-molding process and has a spherical or bottle-shaped shape.

3. The filter apparatus as claimed in claim 1, wherein the filtrate riser tube is inserted into a layer of a hydrophilic foam material or filter fleece arranged on the base of the container and, on the inserted end section, affords holes for the entry of filtered filtrate into the filtrate riser tube.

4. The filter apparatus as claimed in claim 1, wherein the upper end region of the filtrate riser tube is held in a stopper, which closes the container neck, wherein the upper end of the filtrate riser tube protrudes out of the stopper.

5. The filter apparatus as claimed in claim 4, wherein the stopper consists of a foamed material or filter fleece, through which the liquid to be filtered can flow.

6. The filter apparatus as claimed in claim 1, wherein the container connector head is either screwed onto the container neck or is pushed on up to an abutment and releasably locked.

7. The filter apparatus as claimed in claim 1, wherein the sealing piston is arranged centrally in a connector unit of the container connector head and is mounted in the container connector head so as to be vertically slidable and is sealingly connected to the filtrate riser tube in the lowered position.

8. The filter apparatus as claimed in claim 1, wherein the upper end of the sealing piston is in drive connection with an eccentric, which can move the sealing piston upwardly and downwardly by a lever which is pivotally mounted on the connector unit of the container connector head.

9. The filter apparatus as claimed in claim 1, further comprising an elongate blind bore formed in the sealing piston, wherein the elongate blind bore extends from the lower end of the sealing piston and is connected at the upper, closed end region to a transverse bore extending in the transverse direction through the sealing piston.

10. The filter apparatus as claimed in claim 1, further comprising two passages, which are provided with external hose connections, extend spaced above one another transversely through the connector unit of the container connector head to the sealing piston.

11. The filter apparatus as claimed in claim 10, whereinc the upper passage is connected to the transverse bore in the sealing piston, in the lowered position of the sealing piston, so that filtrate can flow out.

12. The filter apparatus as claimed in claim 1, wherein the lower passage is connected, in the lowered position of the sealing piston, to an annular gap, which extends around the sealing piston and extends to the lower end of the container connector head so that supplied liquid can flow out of the annular gap through the stopper into the interior of the container.

13. The filter apparatus as claimed in claim 1, further comprising a venting passage with a venting valve extends from the exterior through the connector unit of the container connector head to an annular gap and that the venting valve affords an actuating head, which opens the venting valve, when a pressure force is exerted.
